(19) United States
(12) Patent Application Publication
(10) Pub. No.: US 2002/0120056 A1
(43) Pub. Date: Aug. 29, 2002

(54) Water dispersible corrosion inhibitor

(76) Inventors: Donald W. Taylor, Liberty, MO (US); Todd W. Scrivens, Lawson, MO (US)

Correspondence Address: MICHAEL K. BOYER, CHIEF PATENT COUNSEL, ORSCHELN MANAGEMENT CO, 2000 US HWY 63 SOUTH, MOBERLY, MO, 65270, US

(21) Appl. No.: 10/005,787

(22) Filed: Nov. 8, 2001

Related U.S. Application Data
(60) Provisional application No. 60/246,886, filed on Nov. 8, 2000.

(51) Int. Cl. C08K 3/00

(52) U.S. Cl. 524/557

(57) ABSTRACT

An environmentally benign and water dispersible corrosion inhibitor is disclosed. The corrosion inhibitor comprises a combination obtained by combining at least one of water dispersible polymers, water soluble silicates, water, additives, among other components.

The subject matter disclosed and claimed herein claims benefit of prior filed U.S. patent application Ser. No. 60/246,886, filed on Nov. 08, 2001; the disclosure of which is hereby incorporated by reference.

### FIELD OF THE INVENTION

The field of the invention relates to corrosion inhibitors for reducing the corrosion rate of metallic surfaces.

### BACKGROUND OF THE INVENTION

It is well know in this art to apply one or more inhibitors upon a metallic surface to reduce the corrosion rate. Conventional corrosion inhibitors typically contain components that are environmentally desirable. Such components are partiuarally undesirable when employed in applications wherein the components may be released upon water or other environmentally sensitive areas.

### SUMMARY OF THE INVENTION

The instant invention solves problems associated with conventional methods by providing an environmentally benign and water dispersible corrosion inhibitor. The inventive corrosion inhibitor comprises a combination obtained by combining at least one of water dispersible polymers, water soluble silicates, water, additives, among other components. The inventive composition is typically employed in applications were relatively short term (depending upon the application) corrosion inhibition is desired. The inventive composition and process can also be employed for increasing the effective life of metallic surfaces previously treated to impart relatively long term corrosion protection, e.g., painted metallic surfaces.

### DETAILED DESCRIPTION

The instant invention relates to compositions, and method for applying the composition to reduce dusting and/or corrosion of a metallic surface. The metallic surface can comprise an anchor chain such as that used on commercial and military boats and ships. The chain can comprise detachable links such as those described in U.S. Pat. No. 5,974,779, issued Nov. 02, 1999 in the named of Orscheln et al.; hereby incorporated by reference.

While the inventive composition can comprise a wide range of components, normally the composition is substantially free of toxic components and those leaving a film or sheen upon water. By “substantially free” it is meant that the composition comprises less than about 10 wt. % and normally about 0 wt. % of such components.

The inventive method can be employed to apply the inventive composition(s) in order to:

1) Use silicates and salt water for corrosion inhibition of metal on ocean vessels or platforms,

2) Use polyvinyl alcohol or silicate blends for corrosion control,

3) Use polyvinyl alcohol as a rust binder for anchor chain or other metal structure,

4) Use silicates as rust binder for anchor chain or other metal structures,

5) Use silicate solutions as deck or platform wash using salt water diluent, among other applications wherein it is desirable to inhibit corrosion.

In one aspect of the invention, the inventive composition comprises at least one of polyvinyl alcohol, ethylene vinyl acetate (and copolymers) thereof, among other water soluble or dispersible and non-toxic polymeric compounds, and water. Normally, the polymeric compound comprises polyvinyl alcohol. The amount of water in the inventive composition normally ranges from about 70 to at least 90 wt. %. If desired, the water can comprise salt water including naturally occurring brackish and ocean/sea water (e.g., water comprising about 5 to at least 7 wt. % sodium chloride). The composition of this aspect of the invention is particularly effective at controlling release of dust and debris from a corroded or rusted surface. If desired, the inventive composition can further comprise at least one de-foaming compound, e.g., a silicon modified dispersion of olefinic solids. The inventive composition can be applied upon an anchor chain (e.g., as the chain is being hoisted and placed into a storage locker upon a boat or ship), in order to reduce, if not eliminate, rust and debris from being released into the air when the anchor is redeployed from the storage locker.

In a second aspect of the invention, the inventive composition comprises at least one water soluble silicate, e.g., sodium silicate, potassium silicate, among other water dispersible silicates, and water. Normally, the water soluble silicate comprises sodium silicate (e.g., density ratio 3:22). The amount of water in the inventive composition normally ranges from about 70 to at least 90 wt. %. If desired, the water can comprise salt water including naturally occurring brackish and salt water (e.g., water comprising about 5 to at least 7 wt. % sodium chloride). The composition has a relatively high pH that ranges from about 8 to about 12, e.g., normally about 11. In general, the higher the pH the greater the effectiveness of the composition at reducing corrosion. If desired at least one pH modifying compound can be added to the composition, e.g., sodium hydroxide. The composition of this aspect of the invention is particuarally effective at controlling release of dust and debris from a corroded or rusted surface as well as reducing the rate of continued corrosion. The inventive composition can be applied upon an anchor chain (e.g., as the chain is being hoisted and placed in a storage locker), in order to reduce corrosion during storage and reduce, if not eliminate, rust and debris from being released into the air when the anchor is redeloyed from the storage locker.

The inventive composition can further comprise at least one additive such as defoaming agents, anti-microbial, surfactants, anti-freeze, dyes, thickeners, among other components. Examples of a suitable anti-freeze materials are proplyene glycol, methanol, among others. Using environment friendly materials is desirable for applications wherein the composition directly contacts water. An example of suitable defoaming agent comprise silicone based agents.

The inventive composition can be prepared by combining the components by using any suitable method. Examples of suitable methods comprise hand mixing, agitation, spray mix heads, among other methods known in the art. The combination rate can be enhanced by heating, e.g., 180 F. for a period of about 30 minutes. In some cases, the composition forms an emulsion.

The inventive composition can be applied upon a desired surface by using any suitable method. Examples of suitable methods comprise dipping, immersing, spraying, wiping, among other delivery methods known in this art. In some cases, it is desirable to prepare a concentrate or an intermediate comprising all components of the inventive composition except water (e.g., salt water). The intermediate is then combined with a readily available source of water (e.g., ocean water in the case of a marine vessel or structure), and applied upon the desired surface. If desired, the intermediate comprises all of the components wherein only a portion of the water (e.g., tap or potable water) is present and remainder of the water (e.g., salt water) is added in situ prior to usage.

While the above description has emphasized using the inventive composition on marine applications, the compositions can be employed on piers (e.g., as a wash and protectant for concrete), pipe flanges and joints before or after welding, as water blast additive for pipe or flange cleaning and repair, temporary coatings during shipment of metallic articles and intermediates (e.g., coil steel, rod used for making wire rope and strand, among others), anchor chain lockers, wash for off-shore structures (e.g., oil rigs), among other applications.

### EXAMPLES

The following Examples are provided to illustrate certain aspects of the instant invention and shall not limit the scope of any claims appended hereto. The following Table lists the components that were used to prepare the aspects of the inventive composition test below.

| Trade Name | Chemical Composition | Supplier |
|---|---|---|
| PQ GRADE G | Sodium silicate solid | PQ Corporation |
| PQ GRADE N | Sodium silicate liquid | PQ Corporation |
| AIRFLEX 500BP | Vinyl acetate emulsion | Air Products |
| AIRVOL 203S | Polyvinyl alcohol | Air Products |
| VINAC RP 710 | Polyvinyl acetate | Air Products |
| DAPRO U-99 | Anionic/non surfactant blend | Elementis |
| DAPRO DF 3163 | Modified polyol foam suppressor | Elementis |
| DAPRO DF 1161 | Silicon modified olefinic solids | Elementis |
| | dispersion foam suppressor | |

| | |
|---|---|
| Material | Amount |

FORMULATION 1

| | |
|---|---|
| AIRVOL 203S | 101.5 g |
| H₂O TAP | 405 cc |

Preparation: MIXED ON HOTPLATE STIRRER @ 185° F.
FOR 30 MINUTES
FORMULATION 2

| | |
|---|---|
| PQ GRADE G | 10 g |
| H₂O TAP | 390 cc |

Preparation: MIXED ON HOTPLATE STIRRER @ 190° F.
FOR 30 MINUTES
FORMULATION 3

| | |
|---|---|
| AIRVOL 203S | 150 g |
| H₂O TAP | 350 cc |

Preparation: MIXED ON HOTPLATE STIRRER @ 190° F.
FOR 30 MINUTES
FORMULATION 4

| | |
|---|---|
| PQ GRADE G | 20 g |
| H₂O TAP | 400 cc |

MIXING: MIXED ON HOTPLATE STIRRER @ 208° F.
FOR 30 MINUTES

The following Table describes the Testing Parameters for the Formulations

| | | |
|---|---|---|
| DESCRIPTION: | | Anchor chain coating for marine applications with |
| | | the primary purpose of eliminating/reducing the |
| | | iron oxide dust generated when anchor is dropped |
| PARAMETERS: | 1. | Spray applied during conventional anchor wash |
| | | down procedures that are employed when anchor |
| | | is hoisted |
| | 2. | Non-flammable. |
| | 3. | Water based to allow coating to be incorporated |
| | | into the current wash down equipment. |
| | 4. | Can not leave oily film or sheen on water as the |
| | | coating will likely go overboard during anchor |
| | | wash down. |
| | 5. | Can not leave long duration foam on water. |
| | 6. | After coating dries, it must dissolve in salt |
| | | water to prevent coating build up which could |
| | | lead to flakes or debris floating on water when |
| | | anchor is deployed or debris clogging chain |
| | | locker drains. |
| | 7. | No environmental hazards or impact. |
| | 8. | Coating concentrate must be able to be diluted to |
| | | working solution strength using sea water as this |
| | | is what the Navy uses for wash down. |
| | 9. | Coating can be applied using commercially |
| | | available equipment. |

### Testing Parameter Descriptions

1. FOAMING: This was a visual observation of foaming characteristics when spray applying the coating/protectant.

2. DISSOLUTION TEST: Formula being tested was applied to a bare steel panel and dried. Pigments and tension modifiers can be added to allow for a uniform coating (bare steel having a different surface tension than corroded steel) and to give a visual indication if coating dissolves. Coated panel was partially immersed in a 5% salt water solution. After 2 hours, coating was checked to see if it is or has dissolved. The water was also checked for film, flakes or oily sheen on the surface.

3. RUB TEST: 10 light double rubs with a white paper towel on a dry anchor chain link. The amount of rust on paper towel is rated from 0 to 5. 0=no rust evident. 5=rust on paper towel same as amount of rust rubbed off uncoated anchor chain (control).

4. SALT FOG: Bare clean chain was coated, allowed to dry and placed into salt fog chamber. The type of chain, coating method, and time in chamber will be noted. Results were compared against uncoated chain of same type (control). Rating is from 1 to 5. 1=more corrosion than control, 2=slightly more, 3=same as control, 4=slightly less, 5=less than control

5. HUMIDITY: Bare clean chain was coated, allowed to dry and placed in a 100 F. oven onto a perforated plastic shelf that is directly above a pan of water. Results were compared against uncoated chain of same type (control). Rating is from 1 to 5. 1 =more corrosion than control, 2=slightly more, 3=same as control, 4=slightly less, 5=less than control

TABLE A
FORMULATION EVALUATION

| | Trial Number | | | |
|---|---|---|---|---|
| | 001 | 002 | 003 | 004 |
| FORMULATION | | | | |
| COMPONENTS | | | | |
| PQ GRADE G | 15 | | | |
| AIRFLEX 500 BP | | 50 | | |
| AIRVOL 203S | | | 15 | |
| VINAC RP710 | | | | 15 |
| H₂O DISTILLED | 100 | | | |
| H₂O TAP | | 50 | 100 | 100 HOT |
| 5% SALT WATER | | | | |
| TESTS | | | | |
| DISSOLUTION TEST | | | DISSOLVED, NO FLAKES, | |
| | | | FILM OR OILY SHEEN ON | |
| | | | WATER | |
| FOAMING | | | FOAMS ON | |
| | | | SPRAYING | |
| RUST RUB OFF | | | | |
| MIXING | STIRRED BY HAND | STIRRED BY HAND | MIXED ON | STIRRED BY HAND |
| | | | HOTPLATE/STIRRER HEAT | |
| | | | SETTING = 2.5 SPEED = 6 | |
| | | | FOR 30 MINUTES | |
| APPLICATION | DIP COAT, HANGER CHAIN | DIP COAT, HANGER CHAIN | DUST TEST-COATING | |
| | | | APPLIED USING GARDEN | |
| | | | SPRAYER SET TO | |
| | | | 8 OZ/GALLON | |
| | | | DISSOLUTION- | |
| | | | FOAM BRUSH, | |
| | | | STEEL PANEL | |

TABLE B
FORMULATION EVALUATION
Trial Number

| | 005 | 006 | 007 | 008 |
|---|---|---|---|---|
| FORMULATION | | | | |
| COMPONENTS | | | | |
| PQ GRADE G | | | | |
| AIR FLEX 500 BP | | 0.3 | | |
| AIRVOL 203S | | | | |
| VINAC RP710 | | | | |
| Formulation 1 | 20 | 2 | 80 | |
| Formulation 2 | | 1 | 20 | |
| Formulation 3 | | | | 100 |
| DAPRO U-99 | | 0.07 | | |
| DAPRO DF 3163 | .25 | 0.07 | 1 | 0.5 |
| H₂O DISTILLED | | | | |
| H₂O TAP | 10 | | | |
| 5% SALT WATER | | | | |
| TESTS | | | | |
| DISSOLUTION TEST | | NO DISSOLUTION | | |
| FOAMING | FOAMS BUT DISSPATES | | | |
| | QUICKLY | | | |
| RUST RUB OFF | | | BETTER THAN CONTROL | POOR-SAME AS |
| | | | BUT NOT RATED | CONTROL BUT NOT |
| | | | | RATED |
| MIXING | MIXED BY HAND | ALL INGREDEINTS ADDED | MIXED BY HAND | MIXED BY HAND |
| | | TO TEST TUBE AND | | |
| | | SHAKEN BY HAND | | |
| APPPLICATION | GARDEN SPRAYER SET AT | FOAM BRUSH, BARE STEEL | GARDEN SPRAYER | GARDEN SPRAYER |
| | 8 OZ/GALLON | | SET AT 8 OZ/ | SET AT 8 OZ/ |
| | | | GALLON. | GALLON. |
| | | | SALTWATER | SALTWATER |
| | | | SOAKED RUSTED | SOAKED RUSTED |
| | | | ANCHOR | ANCHOR |
| | | | CHAIN COATED | CHAIN. COATED |
| | | | WHILE STILL | WHILE STILL WET |
| | | | WET | |
| COMMENTS | NO SUBSTRATE COATED, | MIXTURE IS STABLE. THIS | BETTER THAN CONTROL | RELATIVELY HIGH |
| | FOAMING | WAS TO TEST THE | ON RUB TEST BUT NOT | |
| | OBSERVATION ONLY | STABILITY OF 500 BP IN A | AS GOOD AS USING | |
| | | PVA SOLUTION AND IF IT | B001-0005 ALONE. | |
| | | ALSO AFFECTED THE | WHEN B0001-0005 | |
| | | COATING SOLUBILITY | ONLY WAS APPLIED THE | |
| | | | SAME METHOD AS ABOVE | |
| | | | WAS USED | |

TABLE C
FORMULATION EVALUATION

| | | PVA (PolyVinyl Alcohol) | | |
|---|---|---|---|---|
| | | RATIO STUDY | PVA RATIO STUDY | PVA RATIO STUDY |
| FORMULATION | | | | |
| COMPONENT | | | | |
| PQ GRADE G | | | | |
| AIRFLEX 500 BP | | | | |
| AIRVOL 203S | 100 | | | |
| VINAC RP710 | | | | |
| Formulation 1 | | NEAT | 10 | 10 |
| Formulation 2 | | | | |
| Formulation 3 | | | | |
| DAPRO U-99 | | | | |
| DAPRO DF 3163 | | | | |
| DAPRO DF 1161 | 2 | | | |
| H₂O DISTILLED | | | | |
| H₂O TAP | 300 | | 10 | 20 |
| 5% SALT WATER | | | | |
| TESTS | | | | |
| RUST RUB OFF | MODERATE, BETTER THAN | RATING = 0 | RATING = 0 | RATING = 1 |
| | 008 BUT NOT AS GOOD AS | | | |
| | USING B001-0005 IN A | | | |
| | 8 OZ/GALLON | | | |
| | RATIO, NOT RATED. | | | |
| MIXING | MIXED ON HOTPLATE | NO MIX, APPLIED NEAT | MIXED BY HAND | MIXED BY HAND |
| | STIRRER @ 190° F. FOR | | | |
| | 30 MIN | | | |
| APPLICATIONS | DILUTED WITH WATER TO | FOAM BRUSH APPLIED TO | FOAM BRUSH APPLIED TO | FOAM BRUSH |
| | GIVE A 9 g PVA PER | A DRY RUSTED ANCHOR | A DRY RUSTED ANCHOR | APPLIED TO A |
| | GALLON DILUTED 009 WAS | CHAIN LINK. DRIED USING | CHAIN LINK. DRIED | DRY RUSTED |
| | PLACED INTO A GRACO | HEAT GUN | USING HEAT GUN | ANCHOR CHAIN |
| | SPRAY GUN AND SPRAYED | | | LINK. DRIED |
| | ONTO A WET ANCHOR | | | USING HEAT GUN |
| | CHAIN THAT HAD | | | |
| | BEEN IMMERSED IN A | | | |
| | 3% SALT WATER SOLUTION | | | |
| COMMENTS | SOLUTION HAS THE SAME | STUDY TO DETERMINE THE | STUDY TO DETERMINE THE | STUDY TO |
| | RATIO THAT WAS | AMOUNT OF PVA NEEDED | AMOUNT OF PVA NEEDED | DETERMINE THE |
| | ATTEMPTED | TO PRODUCE AN | TO PRODUCE AN | AMOUNT OF PVA |
| | WITH 008 IN THE 8 OZ/ | ACCEPTABLE COATING. | ACCEPTABLE COATING. | NEEDED TO |
| | GALLON SPRAYER . . . | B001-0005 NEAT | 10 g OF B001-0005 | PRODUCE AN |
| | | EQUATES TO 2 g | DILUTED WITH 10 cc OF H₂O | ACCEPTABLE |
| | | PVA/8 cc H₂O | EQUATES TO 2 g OF PVA TO | COATING. . . 10 g |
| | | | 18 cc H₂O | OF B001-0005 |
| | | | | DILUTED WITH |
| | | | | 20 cc OF H₂O |
| | | | | EQUATES TO 2 g OF |
| | | | | PVA TO 28 cc H₂O |

TABLE D
FORMULATION EVALUATION

| | PVA RATIO STUDY | 010 | 011 | 012 |
|---|---|---|---|---|
| FORMULATION | | | | |
| COMPONENT | | | | |
| PQ GRADE G | | | | |
| AIRFLEX 500 BP | | | | |
| AIRVOL 203S | | 40 | 40 | 40 |
| VINAC RP710 | | | | |
| Formulation 1 | 10 | | | |
| Formulation 2 | | | | |
| Formulation 3 | | | | |
| Formulation 4 | | | | 300 |
| DAPRO U-99 | | | | |
| DAPRO DF 3163 | | | | |
| DAPRO DF 1161 | | 1 | 1 | 1 |
| H₂O DISTILLED | | | | |
| H₂O TAP | 52 | 300 | 300 | |
| 5% SALT WATER | | | | |
| TESTS | | | | |
| RUST RUB OFF | RATING = 1 | RATING = 1 | RATING = 1 | |
| SALT FOG | | 16 HOURS, RATING = 3 | | |
| MIXING | MIXED BY HAND | MIXED ON HOTPLATE | MIXED ON HOTPLATE | MIXED ON |
| | | STIRRER @ 19O° F. FOR | STIRRER @ 19O° F. FOR | HOTPLATE |
| | | 30 MIN | 30 MIN | STIRRER @ 190° F. |
| | | | | FOR 30 MIN |
| APPLICATION | FOAM BRUSH APPLIED TO | RUB TEST-DILUTED AND | DILUTED AND APPLIED | NOT TESTED |
| | A DRY RUSTED ANCHOR | APPLIED USING A | USING A PRESSURE | |
| | CHAIN LINK. DRIED USING | PRESSURE SPRAYER TO | SPRAYER TO A | |
| | HEAT GUN | A WET RUSTED ANCHOR | WET RUSTED ANCHOR | |
| | | CHAIN LINK THAT HAD | CHAIN LINK THAT | |
| | | BEEN IMMERSED IN A 3% | HAD BEEN IMMERSED IN | |
| | | SALT WATER SOLUTION. | A 3% SALT WATER | |
| | | CHAIN WAS ALLOWED | SOLUTION. CHAIN | |
| | | TO AIR DRY. | WAS ALLOWED TO AIR | |
| | | SALT FOG-DILUTED AND | DRY. | |
| | | DIP APPLIED TO BARE | | |
| | | CLEAN HANGER CHAIN | | |
| | | AND ALLOWED TO | | |
| | | DRY THEN PLACED INTO | | |
| | | SALT FOG ALONG WITH | | |
| | | AND UNCOATED HANGER | | |
| | | CHAIN | | |
| COMMENTS | STUDY TO DETERMINE THE | DILUTED WITH 900 cc H₂O | DILUTED WITH 900 cc OF 5% | |
| | AMOUNT OF PVA NEEDED | EQUATES TO 1 g OF PVA TO | SALT WATER. THIS IS THE | |
| | TO PRODUCE AN | 30 cc H₂O THE RUB TEST IS | SAME BATCH AS 010 BUT | |
| | ACCEPTABLE COATING . . . | ACCEPTABLE. | SALT WATER IS USED AS | |
| | 10 g OF B001-0005 | | THE DILUENT TO CHECK | |
| | DILUTED WITH 52 cc | | IT EFFECT ON SOLUTION | |
| | OF H₂O EQUATES | | STABILITY AND COATING | |
| | TO 1 g OF PVA 30 cc | | PERFORMANCE. SOLUTION | |
| | H₂O | | IS STABLE AND | |
| | | | PERFORMANCE IS SAME AS | |
| | | | 010 | |

TABLE E
FORMULATION EVALUATION

| | Trial Number | |
|---|---|---|
| | 013 | 014 |
| FORMULATION | | |
| COMPONENT | | |
| PQ GRADE G | | |
| PQ GRADE N (liquid) | 100 | 300 |
| AIRVOL 203S | | |
| VINAC RP710 | | |
| Formulation 1 | | |
| Formulation 2 | | |
| Formulation 3 | | |
| Formulation 4 | | |
| DAPRO U-99 | | |
| DAPRO DF 3163 | | |
| DAPRO DF 1161 | | |
| H₂O DISTILLED | | |
| H₂O TAP | | |
| 5% SALT WATER | | 300 |
| TESTS | | |
| RUST RUB OFF | RATING = 0 | RATING = 1 |
| SALT FOG | | RATING = 1 |
| MIXING | NONE, USED NEAT | MIXED BY HAND |
| APPLICATION | FOAM BRUSH | RUB TEST-APPLIED |
| | APPLIED TO DRY | USING A PRESSURE |
| | RUSTED ANCHOR | SPRAYER TO A |
| | CHAIN, DRIED | WET RUSTED |
| | WITH HEAT GUN | ANCHOR CHAIN |
| | | LINK THAT |
| | | HAD BEEN |
| | | IMMERSED IN A |
| | | 3% SALT WATER |
| | | SOLUTION. CHAIN |
| | | WAS ALLOWED TO |
| | | AIR DRY SALT |
| | | FOG-APPLIED |
| | | USING A |
| | | PRESSURE |
| | | SPRAYER TO |
| | | CLEAN BARE |
| | | HANGER CHAIN |
| | | AND ALLOWED |
| | | TO DRY |
| COMMENTS | ANCHOR CHAIN | DILUTED WITH |
| | HAS SURFACE | SALT WATER |
| | CORROSION AND | |
| | PITTING BUT | |
| | LITTLE SCALE. | |
| | COATINGS | |
| | SEEM TO SOAK | |
| | INTO THIS | |
| | TYPE OF | |
| | SURFACE. | |

The following is claimed:

1) A composition comprising a combination comprising at least one water dispersible polymer selected from the group consisting of vinyl acetate, vinyl acetate copolymers, vinyl acetate emulsion, polyvinyl acetate and polyvinyl alcohol, water and at least one additive.

2) A composition comprising a combination comprising polyvinyl alcohol, at least one silicon containing foam suppressant, water, and sodium chloride.

3) The composition of claim 1 wherein the water comprises naturally occurring salt containing water.

4) The composition of claim 2 wherein the water comprises naturally occurring salt containing water.

5) The composition of claim 1 further comprising at least one water soluble silicate.

6) The composition of claim 2 further comprising at least one water soluble silicate.

7) The composition of claim 1 wherein said composition has a basic pH.

8) The composition of claim 2 wherein said composition has a basic pH.

9) The composition of claim 1 wherein said water dispersible polymer comprises at least one of vinyl acetate and copolymers thereof.

10) The composition of claim 1 wherein said water dispersible polymer comprises at least one vinyl acetate emulsion.
